(19) United States
(12) Patent Application Publication
(10) Pub. No.: US 2011/0242797 A1
(43) Pub. Date: Oct. 6, 2011

(54) BACKLIGHT UNIT AND METHOD FOR MANUFACTURING THE SAME

(76) Inventors: Ik-Seong PARK, Osan-si (KR); Sang Min KANG, Yongin-si (KR)

(21) Appl. No.: 12/829,655

(22) Filed: Jul. 2, 2010

(30) Foreign Application Priority Data
Oct. 9, 2009 (KR) 10-2009-0096358

(51) Int. Cl. G02F 1/13357

(52) U.S. Cl. 362/97.3; 29/592.1

(57) ABSTRACT

A method for manufacturing a backlight unit and a backlight apparatus are provided. The backlight unit includes a printed circuit board (“PCB”) having a plurality of inserting holes, a plurality of light-emitting diode (“LED”) package having a heat sink and inserted into the inserting hole and exposing the heat sink at a side of the PCB and a bottom chassis combining to the PCB. The heat sink of LED package is adhering to the bottom chassis. According to the present invention, the heat dissipation improves since the heat sink makes direct contact to the bottom chassis.

### PRIORITY

This application claims priority under 35 U.S.C. §119(a) to Korean Patent Application No. 10-2009-0096358, filed on Oct. 9, 2009 in the Korean Intellectual Property Office (KIPO), the contents of which are herein incorporated by reference in their entirety.

### BACKGROUND OF THE INVENTION

1. Field of the Invention

The present invention relates to a backlight unit and a method for manufacturing the same. More particularly, the present invention relates to a backlight unit combining a light emitting diode module and a bottom chassis and a method for manufacturing the same.

2. Description of the Related Art

In conventional display device such as TV or computer monitor, a CRT is used. The CRT is replaced with an LCD (Liquid Crystal Display) panel or a plasma panel recently.

Generally, a display device using LCD panel includes an LCD panel and a backlight unit emitting light to the LCD panel. In the backlight unit with a direct type, a light source is combined with a bottom chassis and each sheet is disposed on the light source and a middle mold and a top chassis are combined on the bottom chassis.

The light source is used with a CCFL (Cold Cathode Fluorescent Lamp), and recently a light-emitting diode package replaces with the CCFL. As the light source, the LED package can use a lower power and display better display quality, however, may generate a lot of heat when the LED is driven. The heat problem must be solved.

In order to solve the heat problem of the LED package, the LED package includes a heat sink. A plurality of the LED packages with the heat sink is mounted on a PCB to form an LED module, and the LED module is combined on the bottom chassis to form a backlight unit.

However, the backlight unit mentioned the above dissipates heat generated in the LED package via the PCB, the heat dissipation efficiency is worsened.

The conventional LED module is combined on the bottom chassis via soldering, the heat for the reflow process during when the combination of the LED module and the bottom chassis may cause a bend of the PCB and the bottom chassis of the LED module.

When the display device is a large display device, the PCB is also designed as a large scale. In the combination of the LED module and the bottom chassis of the large display device, as well as the bend by the heat, a gap of the large PCB may be happened.

Moreover, the static electricity generated by the friction can damage the LED package mounted on the PCB during when the combination of the LED module and the bottom chassis.

### SUMMARY OF THE INVENTION

The present invention provides a backlight unit. The present invention also provides a method for manufacturing a backlight unit.

In one aspect of the present invention, a backlight unit includes a printed circuit board (“PCB”) having a plurality of inserting holes, a plurality of light-emitting diode (“LED”) package having a heat sink and inserted into the inserting hole and exposing the heat sink at a side of the PCB and a bottom chassis combining to the PCB. The heat sink of LED package is adhering to the bottom chassis.

In an exemplary embodiment, the PCB includes at least one more anti-heat deflection slit, which penetrates the PCB.

In an exemplary embodiment, the bottom chassis includes at least one more anti-bending groove.

In an exemplary embodiment, the LED package includes a LED chip and a zener diode electrically connected to both ends of the LED chip in parallel.

In an exemplary embodiment, the backlight unit may further include a dummy LED package inserted into one of the inserting holes. The dummy LED package includes a zener diode electrically connected to the a plurality of the LED packages.

In an exemplary embodiment, the backlight unit may further include a zener diode mounted on the PCB or the bottom chassis. The zener diode is electrically connected to a plurality of the LED packages in parallel.

In another aspect of the present invention, a method for manufacturing a backlight unit includes preparing a printed circuit board (“PCB”) having a plurality of inserting holes, inserting a plurality of light-emitting diode (“LED”) packages having a heat sink into each of the inserting holes to expose the heat sink at a side of the PCB, mounting the PCB having the LED packages on the bottom chassis, and disposing a plurality of magnetic substance to adhere the PCB to the bottom chassis and bonding the heat sink exposed at the one side of the PCB to the bottom chassis.

In an exemplary embodiment, the step of bonding the heat sink to the bottom chassis includes providing solder or thermal paste between the heat sink and the bottom chassis and bonding the heat sink and the bottom chassis by heating.

According to the present invention, the heat sink of the LED package makes direct contact to the bottom chassis, so that the heat dissipate efficiency generated in the LED module may improve.

Moreover, the bending of the PCB and the gap of the PCB caused by the heat of the reflow process is prevented by using the PCB with the slit, the bottom chassis with the groove and the magnetic substance.

Moreover, since the zener diode removes the electrostatic damage, the static electricity generated by friction or something is prevented from damaging when the combination of the LED module to the bottom chassis.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating a backlight unit in accordance with the present invention;

FIG. 2 is a cross-sectional view illustrating a light-emitting diode (“LED”) module taken along a line A-A′ of FIG. 1;

FIG. 3 is a plan view illustrating a slit of the PCB in FIG. 1;

FIG. 4 is a cross-sectional view illustrating a groove of the bottom chassis in FIG. 1;

FIG. 5 is a plan view illustrating the LED package having a zener diode;

FIG. 6 is a plan view illustrating a dummy LED package having a zener diode;

FIG. 7 is a plan view illustrating a PCB having a zener diode;

FIG. 8 is a plan view illustrating a bottom chassis having a zener diode;

FIG. 9 is a flow chart illustrating a method for manufacturing a backlight unit in accordance with the present invention; and

FIG. 10 is a cross-sectional view illustrating a method for manufacturing a backlight unit by using a magnetic substance.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

Hereinafter, the present invention will be described in detail with reference to the accompanying drawings.

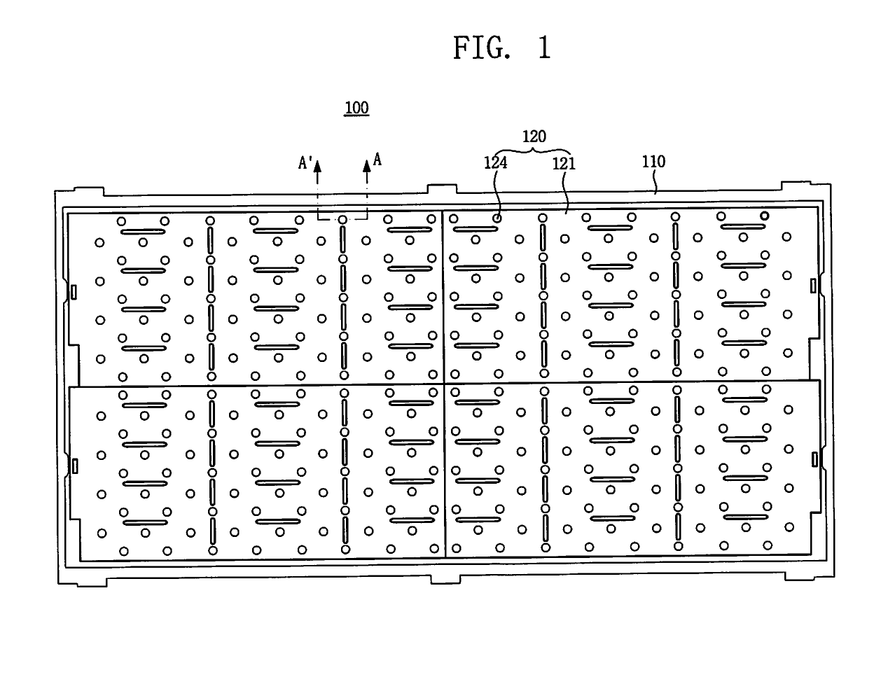

FIG. 1 is a plan view illustrating a backlight unit in accordance with the present invention.

Referring to FIG. 1, a backlight unit 100 in accordance with the present invention includes a bottom chassis 110 and a light-emitting diode (“LED”) module 120. The LED module 120 includes four printed circuit boards (“PCBs”) 121 and a plurality of LED package 124 mounted on the PCBs 121.

Referring to a part of one of the LED package 124 of the LED module 120 combined to the bottom chassis 110, the combination structure of the bottom chassis 110 and the LED module 120 will be described in detail.

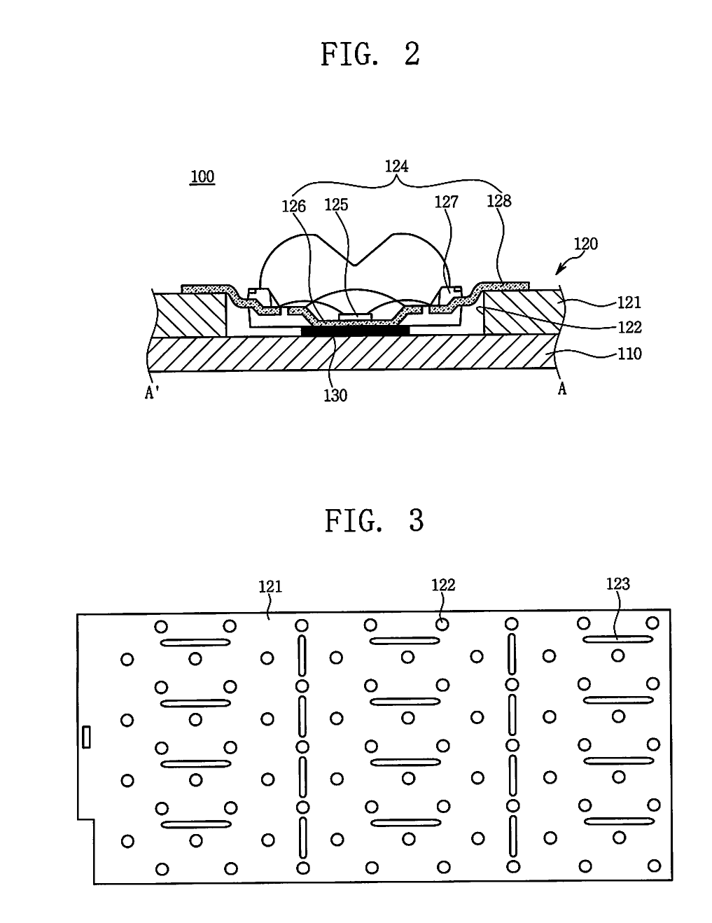

FIG. 2 is a cross-sectional view illustrating a light-emitting diode (“LED”) module taken along a line A-A′ of FIG. 1.

Referring to FIG. 2, the LED module 120 is mounted on the bottom chassis 110 of the backlight unit 100 in accordance with the present invention.

The bottom chassis 110 is a member protecting the LED module 120, on which the LED module 120 is mounted. The bottom chassis 110 dissipates heat generated when the LED module 120 is driven, and functions as a heat sink. The bottom chassis 110 may include high thermal-conductive substance. The bottom chassis 110 may include steel plate, which has high thermal-conductive metal.

The LED module 120 includes a PCB 121 having an inserting hole 122 and a LED package 124 mounted to the PCB 121 by inserting into the inserting hole 122.

The LED package 124 includes a housing 127, a heat sink 126 exposed under the housing 127 for heat dissipation, a LED chip 125 mounted on the heat sink 126 and an electrode 128, which is wire-bonded with the LED chip 125 and soldered to the PCB 121. The PCB 121 includes a circuit pattern (not shown) electrically connected to the electrode 128 of the LED package 124 and an inserting hole 122 to which the LED module 120 is inserted.

The housing 127 of the LED package 124 is inserted into the inserting hole 122 of the PCB 121 and the electrode 128 of the LED package 124 is electrically connected to the circuit pattern of the PCB 121 so that the LED package 124 is mounted on the PCB 121. Thus, the heat sink 126 of the LED package 124 is exposed to one side of the PCB 121 through the inserting hole 122.

The LED module 120 may be mounted on the bottom chassis 110 by the reflow process of the solder 130. In particular, the heat sink 126 of the LED package 124 exposed downward to the lower part of the PCB 121 through the inserting hole 122 is bonded to the bottom chassis 110 by through the reflow process using the solder 130.

By the process mentioned the above, the heat sink 126 of the LED package 124 is directly contacted to the bottom chassis 110 by medium, which is the solder 130. When the LED package 124 is driven, the heat generated in the LED chip 125 does not dissipate through the PCB 121 having low thermal-conductivity and dissipates directly outward through the heat sink 126, the solder 130 and the bottom chassis 110 having high thermal-conductivity, not through the PCB 121 having low thermal-conductivity, directly outward.

The backlight unit 100 in accordance with the present invention has more excellent heat dissipation efficiency than the conventional unit, which dissipate the heat generated in the LED chip 125 through the PCB 121.

In the present embodiment, the LED module 120 is mounted on the bottom chassis 110 by the solder 130. However, the method for mounting the LED module 120 on the bottom chassis 110 is not limited to the method by solder 130. The LED module 120 may be mounted on the bottom chassis 110 by using high thermal conductivity and high adhesive member such as thermal paste, for example.

The PCB 121 of the backlight unit of the present embodiment may include a slit (not shown) for protecting the PCB 121 from bending. The bottom chassis 110 of the backlight unit may include a groove (not shown) for protecting the bottom chassis 110 from bending.

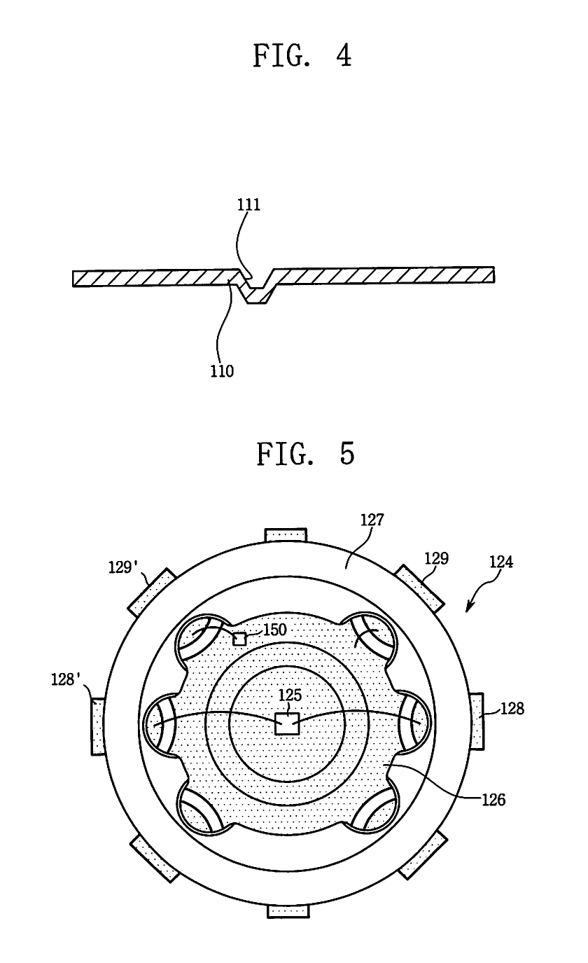

The PCB 121 or the bottom chassis 110 may be bended from the original shape by providing the heat of the reflow process to the PCB 121 or the bottom chassis 110 when the LED module 120 is mounted on the bottom chassis through the reflow process. The slit protects the PCB 121 from bending when the solder 130 is in the reflow process, and the groove protects the bottom chassis 110 from bending when the solder 130 is in the reflow process. The slit and groove will be described in FIGS. 3 and 4.

FIG. 3 is a plan view illustrating a slit of the PCB in FIG. 1.

Referring to FIG. 3, a plurality of slits 123 is formed in the PCB 121 for protecting the PCB 121 from bending. The slit 123 is a penetrating hole of a stick shape, which penetrates the PCB 121. The slit 123 may be formed so as not to overlap with the circuit pattern (not shown) of the PCB 121 or the inserting hole 122 of the PCB 121.

A plurality of slits 123 may be arranged in a certain rule regular interval on the PCB 121. A plurality of slit 123 of the present embodiment is formed in a horizontal arrangement and a vertical arrangement in turns with constant intervals on the PCB 121. A plurality of the slits 123 may be formed on the PCB 121 irregularly.

The slit 123 formed on the PCB 121 is vain space in contrast to the other part of the PCB 121. The slit 123 prevents the heat transfer and protects the PCB 121 from bending when the PCB is heated by when the reflow process of the solder 130. Thus, the bend of the PCB 121 may be preventable.

The slit 123 of the present embodiment is described as a penetrating hole of a stick shape. However, the shape of the slit 123 is not limited to the shape and may include a lot of other shapes. For example, the slit 123 may include a polygon shape such as a pentagon, a diamond, a hexagon and so on or a circular shape such as a circle or an oval shape.

FIG. 4 is a cross-sectional view illustrating a groove of the bottom chassis in FIG. 1.

Referring to FIG. 4, the bottom chassis 110 includes a groove 111 preventing the bottom chassis 110 from bending. The groove 111 is an indentation groove of a stick shape formed by down-setting a part of the bottom chassis 110 by pressing method. The groove 111 may be plural. In particular, the groove 111 is formed as a recess shape at a side facing the LED module, and is formed as a protrusion at the other side, which is an outer side of the bottom chassis 110.

The groove 111 formed on the bottom chassis 110 has a recess in contrast to the other part of the bottom chassis 110. The groove 111 buffers the heat expansion and prevents the spread of the bend of the bottom chassis 110 when the bottom chassis 110 is heated and expended in the reflow process. Thus, the entire shape of the bottom chassis 110 may be preventable.

In the present embodiment, the shape, the length and the arrangement of the groove 111 may be flexible as mentioned in the description of the slit in FIG. 3. The detail description will be omitted because the skilled person can easily understand from the description in FIG. 3.

Moreover, the backlight unit 100 of the present embodiment may include an electrostatic discharge (“ESD”) member for preventing the electrostatic damage. The electrostatic may be generated when the LED module is mounted on the bottom chassis or when the backlight unit is driven. The ESD member may be disposed on the LED package 124, the PCB 121, the bottom chassis 110 and the dummy LED package of the backlight unit. The ESD member may include a schottky barrier diode, a barrister, preferably a zener diode.

Hereinafter, the ESD member will be described as the zener diode. A Zener diode is a type of diode that permits current not only in the forward direction like a normal diode, but also in the reverse direction if the voltage is larger than the breakdown voltage known as “Zener knee voltage” or “Zener voltage”.

Hereinafter, the LED member is a bidirectional zener diode which is disposed at front end of a semiconductor device or a protected circuit, which bypasses the forward and backward current by the high peak voltage, and which have only low voltage be applied to the semiconductor or the protected circuit.

FIG. 5 is a plan view illustrating the LED package having a zener diode.

Referring to FIG. 5, the zener diode 150 is formed on the LED package 124 with the LED chip 125. Both ends of the LED chip 125 are electrically connected to the electrodes 128, 128′ of the LED package 124 with wires. The zener diode 150 is formed in the housing 127 to insulate the heat sink 126, and both ends of the zener diode 150 is electrically connected to the other electrodes 129, 129′ of the LED package 124 with wires. The electrodes 128 and the electrodes 129 of the LEDC package 124 are electrically connected to each other, and the electrode 128′ and the electrode 129′ are electrically connected. Thus, the zener diode 150 is electrically connected to both ends of the LED chip 125 in parallel.

When the zener diode 150 is formed on the Led package 124, the zener diode 150 bypasses the current by the high peak voltage even though the high peak voltage (electrostatics) is applied to the LED package 124. Thus, the zener diode 150 protects the LED chip 125 from the electrostatics.

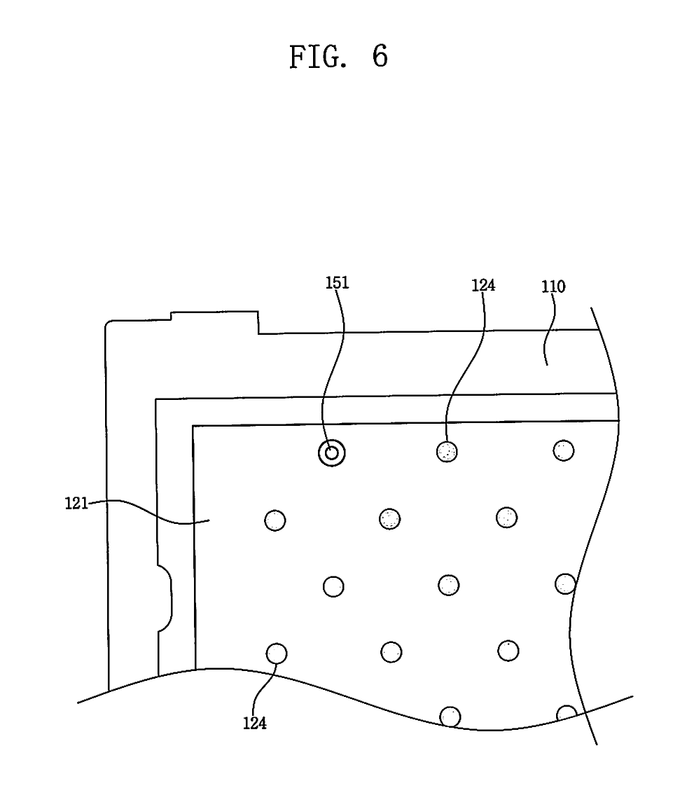

FIG. 6 is a plan view illustrating a dummy LED package having a zener diode. The dummy LED package 151 is defined as the LED package form mounting the zener diode at the position for mounting the LED chip 125 in at the LED package. Both ends of the zener diode may be connected to both ends of the package with wire-bonding such as both ends of the LED chip 125.

Referring to FIG. 6, the dummy LED package 151 may be disposed on the PCB 121 by inserting the inserting hole 122 of the PCB 121. The dummy LED package 151 may be electrically connected in parallel to the protected circuit on the PCB 121. The protected circuit includes a circuit connected with a plurality of the LED packages 124 or and a driving circuit of the LED package 124.

The dummy LED package 151 bypasses the current by the high peak voltage even though the high peak voltage (electrostatics) is applied to the protected circuit, thereby, the protecting the protected circuit from the electrostatics. The numeric reference 110 refers to the bottom chassis.

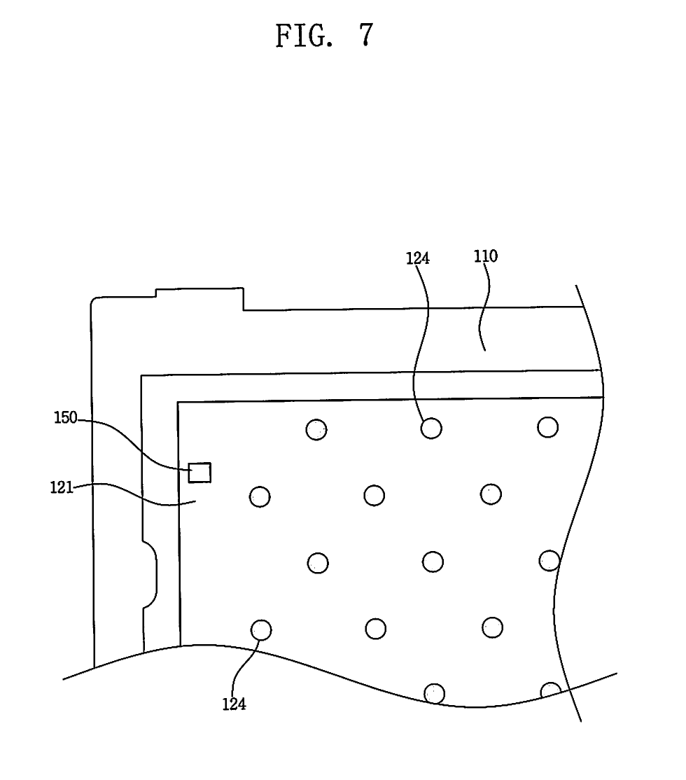

FIG. 7 is a plan view illustrating a PCB having a zener diode. Referring to FIG. 7, the zener diode 150 may be formed in the area of the PCB 121 where the LED package 124 is not disposed. Preferably, the zener diode 150 may be disposed at the power input member of the PCB 121 in parallel.

The numeric reference 110 refers to the bottom chassis. The logic of the zener diode 150 protecting the protected circuit may be understandable by the skilled person from the description in FIG. 5. Thus, the detail description will be omitted. The protected circuit includes a circuit connected to a plurality of the LED packages 124 or and a circuit for driving the LED package 124.

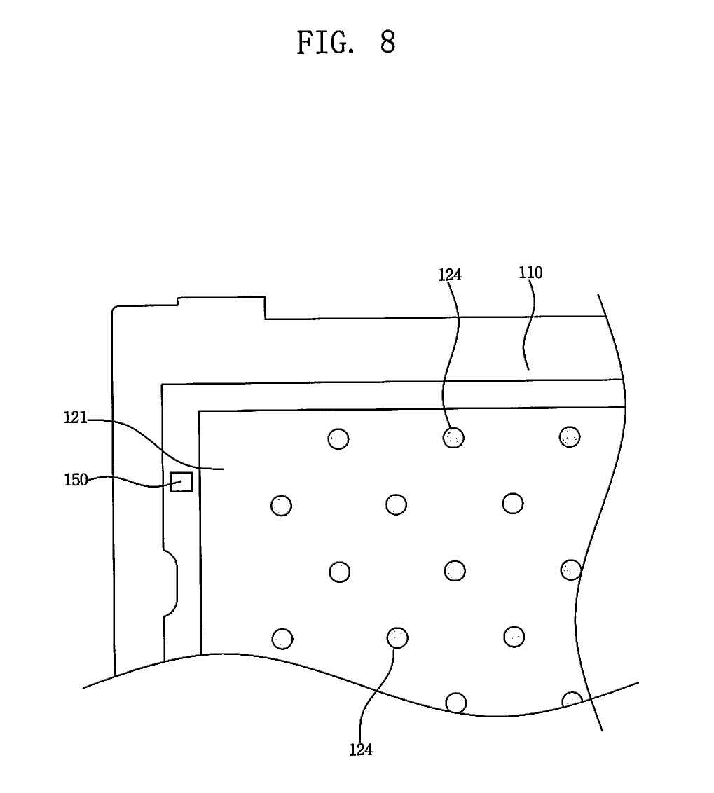

FIG. 8 is a plan view illustrating a bottom chassis having a zener diode. Referring to FIG. 8, the zener diode 150 is formed on the bottom chassis 110. Both ends of the zener diode 150 may be connected to the protected circuit or a front end of a device in parallel. The protected circuit or device includes the LED package 124 mounted on the PCB 121 or the driving circuit for the LED package 124. The logic of the zener diode 150 protecting the protected circuit may be understandable by the skilled person from the description in FIG. 5. Thus, the detail description will be omitted.

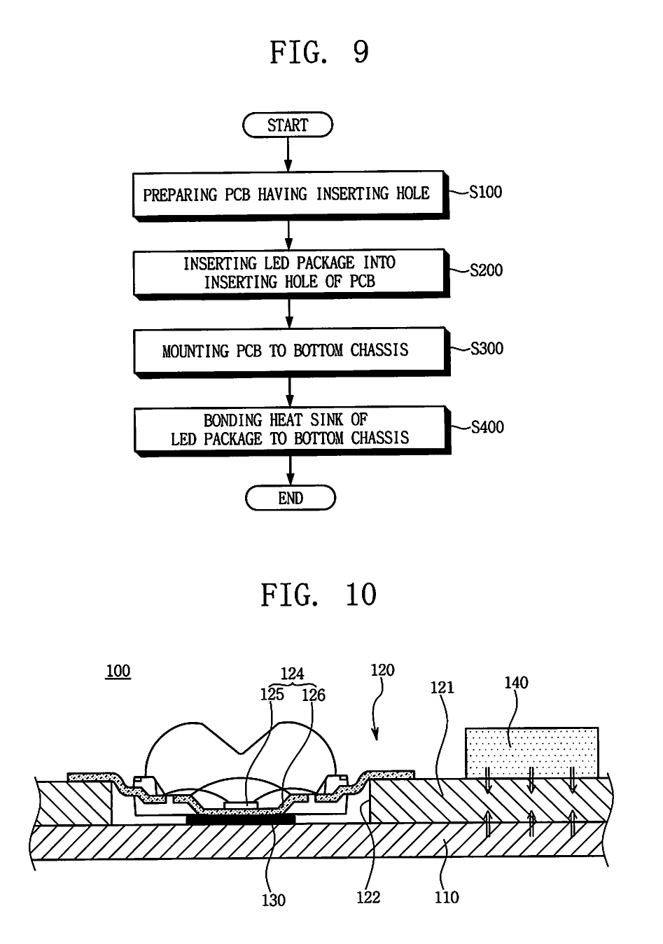

FIG. 9 is a flow chart illustrating a method for manufacturing a backlight unit in accordance with the present invention.

Referring to FIG. 9, a method for manufacturing a backlight unit in accordance with an embodiment of the present invention includes preparing a printed circuit board (“PCB”) having a plurality of inserting holes (S100). The PCB may be the PCB in FIG. 2 or 3.

A plurality of light-emitting diode (“LED”) packages having a heat sink is inserted into each of the inserting holes to expose the heat sink at a side of the PCB (S200).

The PCB having the LED packages is mounted on the bottom chassis, and is disposed a plurality of magnetic substance to adhere the PCB to the bottom chassis (S300).

The heat sink exposed at the one side of the PCB is bonded to the bottom chassis (S400). Solder or thermal paste may be provided between the heat sink and the bottom chassis, and the heat sink and the bottom chassis may be bonded by heating.

When the LED module is bonded on the bottom chassis, the step of S300 for preventing a gap between of the PCB and the bottom chassis will be described in FIG. 10.

FIG. 10 is a cross-sectional view illustrating a method for manufacturing a backlight unit by using a magnetic substance.

Referring to FIG. 10, when the LED module 124 is mounted on the bottom chassis 110, the magnetic substance 140 is mounted on the PCB 121 for preventing a gap between of the PCB 121 and the bottom chassis 110.

The magnetic substance 140 has a property attracting the metallic substance such as a steel plate, so and the magnetic substance 140 mounted on the PCB 121 attracts the bottom chassis 110 under the PCB 121 and adheres to the PCB 121.

Thus, the magnetic substance 140 is mounted on the PCB 121 when the reflow process mounting the LED module 124 on the bottom chassis 110, thereby, reducing a gap between the heat sink 126 and the bottom chassis 110 by moving the PCB 121 from the bottom chassis 110 in the cooling process after reflowing the solder 130.

The magnetic substance 140 is used in the process in which the LED module 120 is bonded to the bottom chassis 110 in accordance with the present embodiment. Thus, the PCB 121 and the bottom chassis 110 is processed in the reflow process with adhering condition, thereby, the heat dissipation of the backlight unit improving.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A backlight unit comprising:
a printed circuit board (“PCB”) having a plurality of inserting holes;
a plurality of light-emitting diode (“LED”) package having a heat sink and inserted into the inserting hole and exposing the heat sink at a side of the PCB; and
a bottom chassis combining to the PCB,
wherein the heat sink of LED package is adhere to the bottom chassis.

2. The backlight unit of claim 1, wherein the PCB comprises at least one more anti-heat deflection slit, which penetrates the PCB.

3. The backlight unit of claim 1, wherein the bottom chassis comprises at least one more anti-bending groove.

4. The backlight unit of claim 1, wherein the LED package comprises a LED chip and a zener diode electrically connected to both ends of the LED chip in parallel.

5. The backlight unit of claim 1, further comprising a dummy LED package inserted into one of the inserting holes,
wherein the dummy LED package comprises a zener diode electrically connected to a plurality of the LED packages.

6. The backlight unit of claim 1, further comprising a zener diode mounted on the PCB or the bottom chassis,
wherein the zener diode is electrically connected to the a plurality of the LED packages in parallel.

7. A method for manufacturing a backlight unit comprising:
preparing a printed circuit board (“PCB”) having a plurality of inserting holes;
inserting a plurality of light-emitting diode (“LED”) packages having a heat sink into each of the inserting holes to expose the heat sink at a side of the PCB;
mounting the PCB having the LED packages on the bottom chassis, and disposing a plurality of magnetic substance to adhere the PCB to the bottom chassis; and
bonding the heat sink exposed at the one side of the PCB to the bottom chassis.

8. The method for manufacturing of claim 7, wherein the step of bonding the heat sink to the bottom chassis comprises:
providing solder or thermal paste between the heat sink and the bottom chassis; and
bonding the heat sink and the bottom chassis by heating.
